(19) United States
(12) Patent Application Publication
(10) Pub. No.: US 2019/0001980 A1
(43) Pub. Date: Jan. 3, 2019

(54) Control Method To Adapt Torque Request Based On Vehicle Load

(71) Applicant: Dana Limited, Maumee, OH (US)

(72) Inventors: Jeffrey M. David, Cedar Park, TX (US); T. Neil McLemore, Georgetown, TX (US)

(21) Appl. No.: 16/024,126

(22) Filed: Jun. 29, 2018

Related U.S. Application Data
(60) Provisional application No. 62/527,097, filed on Jun. 30, 2017.

(51) Int. Cl. B60W 30/188; B60W 50/00; B60W 40/13

(52) U.S. Cl. CPC B60W 30/188; B60W 50/00; B60W 40/13; B60W 2530/10; B60W 2050/0026; B60W 20/15; B60W 2540/10; B60W 2520/28; B60W 2550/142; B60W 2510/0628; B60W 2050/0014

(57) ABSTRACT

Provided herein is a vehicle including a powertrain including a prime mover operably coupled to a transmission, wherein the transmission is operably coupled to a plurality of wheels; a plurality of sensors configured to monitor operating conditions of the vehicle including an accelerator pedal position; and a controller configured to receive signals from the plurality of sensors and send an output signal to control a torque request to the powertrain, wherein the controller includes a calibrateable map having values of the torque request based on the accelerator pedal position and an estimated weight of the vehicle.

### RELATED APPLICATION

The present application claims priority to U.S. Provisional patent application Ser. No. 62/527,097 filed on Jun. 30, 2017, which is incorporated herein by reference in its entirety.

### BACKGROUND

Modern vehicles typically use a map which relates accelerator pedal position to a driver demanded torque or power. This map does not account for major changes in vehicle weight. For operation where the vehicle weight is changing, the driver presses the accelerator pedal harder to request more torque when the vehicle is in a heavier condition. Operating the vehicle in this way does not provide a consistent pedal to vehicle speed/acceleration relationship with weight change. For the situation of a postal/vehicle, the vehicle can see a massive change in weight during the course of one driving cycle. Providing a consistent speed/acceleration relative to the pedal position provides increased drivability.

### SUMMARY

Provided herein is a vehicle including: a powertrain including a prime mover operably coupled to a transmission, wherein the transmission is operably coupled to a plurality of wheels; a plurality of sensors configured to monitor operating conditions of the vehicle including an accelerator pedal position; and a controller configured to receive signals from the plurality of sensors and send an output signal to control a torque request to the powertrain.

In some embodiments, the controller includes a calibrateable map having values of the torque request based on the accelerator pedal position and an estimated weight of the vehicle.

In some embodiments, the estimated weight is determined using a weight estimator process adapted to receive the plurality of signals including a wheel speed, a grade, and a mass air flow.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the preferred embodiments are utilized, and the accompanying drawings of which:

FIG. 1 is a schematic illustration of a vehicle having a powertrain and a variable payload.

FIG. 2 is a chart depicting the relationship of a vehicle acceleration based on accelerator pedal position and vehicle weight.

FIG. 3 is a block diagram of a powertrain controller that is implementable on the vehicle of FIG. 1.

FIG. 4 is a block diagram of another powertrain controller that is implementable on the vehicle of FIG. 1

FIG. 5 is a block diagram of a weight estimation process that is implementable in the powertrain controller of FIG. 4.

### DETAILED DESCRIPTION OF THE PREFERRED EMBODIMENTS

The preferred embodiments relate to controlling the operating conditions of a vehicle that experiences a change in weight (or payload) over the course of operation due to the loading and unloading of material and items from the vehicle.

Typically, vehicles of these types are equipped with powertrains having a prime mover coupled to wheels.

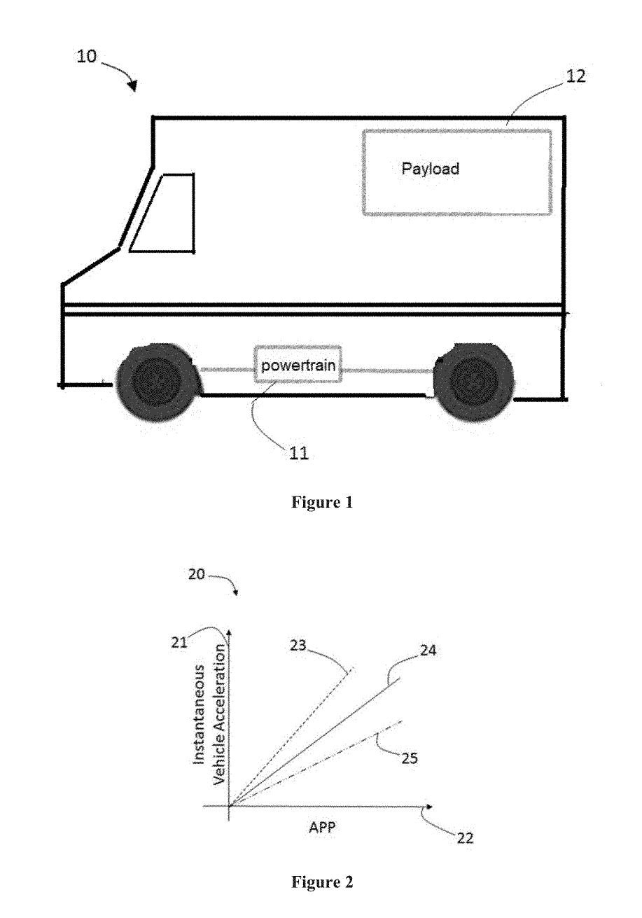

Referring now to FIG. 1, in some embodiments, a vehicle 10 includes a powertrain 11 configured to provide propulsion to the vehicle 10 for transporting a payload 12.

In some embodiments, the powertrain 11 includes a prime mover operably coupled to a multiple speed gearbox configured to transmit rotational power to a set of rear wheels and/or front wheels of the vehicle 10.

In some embodiments, the prime mover is an internal combustion engine, an electric motor, or a combination thereof.

In some embodiments, the powertrain 11 is equipped with an electric hybrid powertrain including an internal combustion engine, one or more electric motors in electrical communication with a battery system, and appropriate couplings to drive the rear wheels and/or the front wheels of the vehicle 10. Several illustrative examples of electric hybrid powertrains that are implementable in the vehicle 10 are disclosed in U.S. patent application Ser. Nos. 15/760,647; 15/760,563; and 15/574,625; which are hereby incorporated by reference. The vehicle 10 is equipped with an accelerator pedal accessible by the driver of the vehicle and adapted to indicate a driver's demand for torque from the powertrain 11.

The powertrain 11 is controlled by an electronic control system (ECU) or controller having a plurality of sensors and actuators operably coupled to the vehicle 10 and components of the powertrain 11.

Turning now to FIG. 2, during operation of the vehicle 10, the relationship between the acceleration of the vehicle 10 to an accelerator pedal position is primarily a function of the vehicle weight, among other factors. FIG. 2 depicts a chart 20 having an x-axis representing an accelerator pedal position 22 and a y-axis representing an instantaneous vehicle acceleration 21. A first line 23 depicts the relationship of the accelerator pedal position 22 to vehicle acceleration 21 for an unloaded vehicle. A second line 24 depicts the relationship of accelerator pedal position 22 to vehicle acceleration 21 for a moderately loaded vehicle. A third line 25 depicts the accelerator pedal position 22 to the vehicle acceleration 21 for a fully loaded vehicle. It is assumed that all of other vehicle conditions are constant among the first line 23, the second line 24, and the third line 25. As the weight of the vehicle 10 increases due to increasing size of the payload 12, the vehicle acceleration 21 decreases for a given accelerator pedal position 22.

In some embodiments, the ECU is adapted to receive a plurality of input signals obtained from sensors equipped on the vehicle, and deliver a plurality of output signals to actuators and controllers provided on the vehicle

In some embodiments, the ECU is configured to receive signals used to monitor the operating condition of the vehicle from an accelerator pedal position sensor, a brake pedal position sensor, input speed sensors, actuator position sensor, temperature sensors, and torque sensors, among others.

In some embodiments, the ECU performs a number of calculations based at least in part on the input signals to thereby generate the output signals. The output signals are received by a number of control modules equipped on the vehicle.

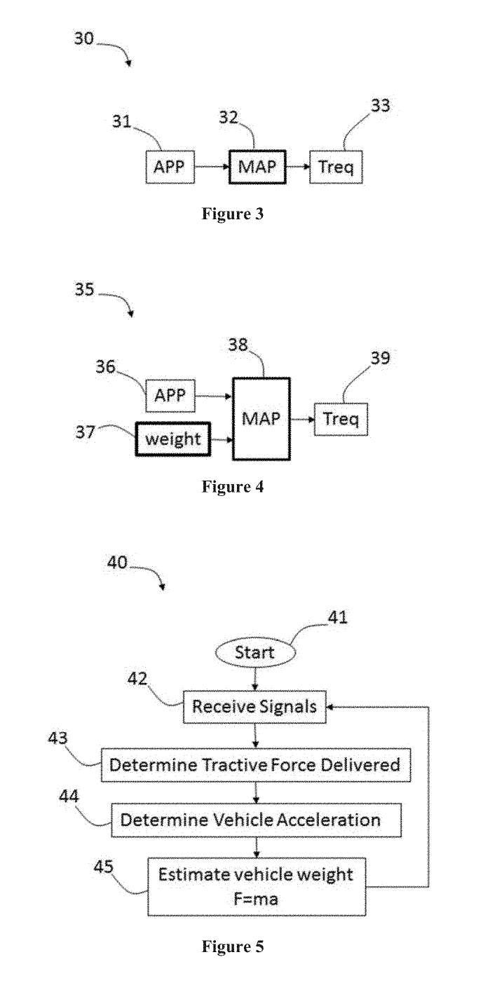

Referring now to FIGS. 3 and 4, in some embodiments, the vehicle 10 is equipped with an ECU that implements a control process 30 relating an accelerator pedal position 31 to a request for torque 33 using a calibrateable map 32.

In some embodiments, during operation of the vehicle 10, the control process 30 can be characterized by the chart 20.

In some embodiments, an adaptive control process 35 is implemented on the vehicle 10 to account for a change in the weight of the vehicle during operation.

In some embodiments, the adaptive control process 35 relates an accelerator pedal position 36 and an estimated weight 37 to a requested torque 39 using a calibration map 38. The requested torque 39 is used by the ECU to send an output signal to command a torque delivered to the wheels of the vehicle 10.

In some embodiments, the estimated weight 37 is determined using ECU that estimates the weight of the vehicle 10 based on of the plurality of sensors equipped on the vehicle 10.

For example, the vehicle 10 is provided with wheel speed sensors to determine vehicle speed and acceleration and a grade sensor, either actual or virtual, for determining the inclination of the vehicle 10.

In some embodiments, the powertrain 11 is equipped with a mass air flow sensor and/or a manifold air pressure sensor on the prime mover that are indicative of torque delivered by the prime mover.

In some embodiments, the powertrain 11 is equipped with a plurality of sensors configured to determine the torque delivered by electric motor(s).

Turning now to FIG. 5, in some embodiments, a weight estimator process 40 is optionally implemented by the ECU to determine the estimated weight 37. The weight estimator process 40 begins at a start state 41 and proceeds to a block 42 where a number of signals are received from the plurality of sensors equipped on the vehicle 10. The weight estimator process 40 proceeds to a block 43 where a a torque delivered to the wheels of the vehicle 10 is determined.

In some embodiments, the block 43 converts the torque delivered to the wheels to a tractive force by dividing the torque by the wheel radius. The weight estimator process 40 proceeds to a block 44 where vehicle acceleration is determined.

In some embodiments, the vehicle acceleration is based on signals received from wheel speed sensors equipped on the vehicle 10. The weight estimator process 40 proceeds to a block 45 where the vehicle weight 37 is determined based on the known relationship of force is equivalent to mass multiplied by acceleration.

Those of skill will recognize that the various illustrative logical blocks, modules, circuits, and algorithm steps described in connection with the embodiments disclosed herein, including with reference to the transmission control system described herein, for example, could be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments.

For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium could be integral to the processor. The processor and the storage medium could reside in an ASIC. For example, in one embodiment, a controller for use of control of the CVT includes a processor (not shown).

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the embodiments described herein may be employed in practicing the invention. It is intended that the following claims define the scope of the preferred embodiments and that methods and structures within the scope of these claims and their equivalents be covered thereby.

What is claimed is:

1. A vehicle comprising:
a powertrain including a prime mover operably coupled to a transmission, wherein the transmission is operably coupled to a plurality of wheels;
a plurality of sensors configured to monitor operating conditions of the vehicle including an accelerator pedal position; and
a controller configured to receive signals from the plurality of sensors and send an output signal to control a torque request to the powertrain, wherein the controller comprises a calibrateable map having values of the torque request based on the accelerator pedal position and an estimated weight of the vehicle.

2. The vehicle of claim 1, wherein the estimated weight is determined using a weight estimator process adapted to receive the plurality of signals including a wheel speed, a grade, and a mass air flow.
